(19) United States
(12) Patent Application Publication
(10) Pub. No.: US 2025/0322540 A1
(43) Pub. Date: Oct. 16, 2025

(54) POSITION DETERMINATION OF A VEHICLE USING IMAGE SEGMENTATIONS

(71) Applicants: Continental Autonomous Mobility Germany GmbH, Ingolstadt (DE); NANYANG TECHNOLOGICAL UNIVERSITY, Singapore (SG)

(72) Inventors: Qiyu Kang, Singapore (SG); Rui She, Singapore (SG); Wee Peng Tay, Singapore (SG); Diego Navarro Navarro, Singapore (SG); Ritesh Khurana, Singapore (SG); Andreas Hartmannsgruber, Singapore (SG); Yong Liang Guan, Singapore (SG)

(73) Assignees: Continental Automotive Technologies GmbH, Hannover (DE); NANYANG TECHNOLOGICAL UNIVERSITY, Singapore (SG)

(21) Appl. No.: 18/866,713

(22) PCT Filed: May 16, 2023
(86) PCT No.: PCT/EP2023/063085

§ 371 Date: Nov. 18, 2024

(30) Foreign Application Priority Data
May 18, 2022 (SG) 10202205185R

(51) Int. Cl. G06T 7/73; G06T 7/12; G06T 7/162

(52) U.S. Cl. CPC G06T 7/74; G06T 7/12; G06T 7/162; G06T 2207/10028; G06T 2207/20084; G06T 2207/30256

(57) ABSTRACT

A method of determining a position of a vehicle in which a reference map is provided. The reference map comprises segmentations of a reference image with landmarks. A measurement image of a vehicle environment is captured and segmentations of the measurement image and neighborhood graphs are determined to obtain a measurement map, wherein a segmentation is represented by a vertex and where a neighborhood graph comprises the vertex and edges containing information to identify neighboring vertices of the vertex. Segmentations of the reference image are compared with the segmentations represented by the vertices of the measurement image and the neighborhood graphs, and segmentations contained in the reference image and in measurement image are determined. The vehicle's position is estimated with reference to the reference map during its movement along a road based on a result of the comparison.

### CROSS-REFERENCE TO RELATED APPLICATIONS

The present application is a National Stage Application under 35 U.S.C. 371 of International Application No. PCT/EP2023/063085 filed on May 16, 2023, and claims priority from Singapore patent application Ser. No. 10202205185R filed on May 18, 2022, in the Intellectual Property Office of Singapore, the disclosures of which are herein incorporated by reference in their entireties.

### BACKGROUND

### 1. Field

Various embodiments relate to methods for determining a position of a vehicle, to a computer program element for determining a position of a vehicle and to a computer program element for determining matching landmark objects.

### 2. Description of Related Art

In autonomous driving, a precisely estimated vehicle position plays a crucial role in the perception, planning, and control functional systems in the autonomous vehicle to perform the driving decisions and actions effectively. The vehicle location is estimated with respect to a global coordinate system, e.g. Earth-centred Inertial (ECI) coordinate system, Earth-centred Earth-fixed (ECEF) coordinate system and Universal Transverse Mercator (UTM) coordinate systems. In structured or open environments, Global Navigation Satellite Systems (GNSS), such as GPS and GLONASS, usually provide sufficiently accurate localization results. More accurate localization for autonomous vehicles in unreliable GNSS scenarios, e.g. urban or tunnel areas where satellite signals are weakened or blocked, is required. Although more advanced GNSS technology like Differential GPS (DGPS) and Real Time Kinematic (RTK) may mitigate the issue by improving the localization accuracy compared to the conventional GPS, they induce higher cost and still suffer from signal availability due to limited signal coverage. Therefore, GNSS cannot be used alone and is often integrated with other sensors in the context of autonomous driving. The inertial navigation system in the autonomous vehicle typically includes Inertial Motion Units (IMU) sensor, wheel odometry sensor, and GPS. The linear accelerations and vehicle angular velocities measured from accelerometers and gyroscopes in IMU, together with the speed and turning measurements from wheel odometry sensors, can be used to estimate the vehicle position relative to its initial position from path integration known as Dead Reckoning technique. This trivial method has low cost in vehicle localization system but suffers from accumulated errors even with advanced algorithms. Besides, the magnitude of the localization errors causes inadequacy for autonomous vehicles. Modern vehicle localization systems commonly depend on additional on-board sensors, like cameras. LiDAR, or radar sensors which are also used for other functions of the autonomous vehicle. e.g. Object Detection and Response. Data fusion, the process of combing information from multi-modal sensory data to provide a robust and complete description for the surrounding environment, is therefore required to perform the localization task with less uncertainty and better accuracy results compared to the case when those sources are used individually. In the literature, filtering methods like the basic Kalman filter and its extensions like Extended Kalman Filter (EKF). Unscented Kalman Filter (UKF) and Sigma-Point Kalman Filters (SPKF) are commonly used. The recursive estimation process allows the probabilistic descriptions of observations from different sensor models to be included in the Bayes update. Furthermore, quantitative evaluation for the role of each sensor towards the overall performance of the system is possible from the consistent use of statistical measures of uncertainty. In general, complex image data from camera sensors or the point clouds data from LASER scanners are inefficient to be directly utilized in the filtering methods even though they provide rich information. Feature extraction techniques are first employed to extract useful information from the raw data. Traditionally, features of interest include simple point features such as corners, edges and blobs from methods like Scale Invariant Feature Transform (SIFT). Speeded Up Robust Features (SURF). Features From Accelerated Segment Test (FAST) and Oriented Fast and Rotated Brief (ORB). In contrast, in deep learning approaches, neural networks with different architectures are applied directly to images or point clouds to exact features of interest to regress the vehicle movement. In localization, a reference global or local map need to be first defined. The reference landmark map stores the detected landmarks during the data collection phase and can be categorized into two types: the grid maps and the topological maps. A grid map is presented by an array of structured cells (e.g. the pixels in an image) where each cell represents a region of the environment and contains features of the landmarks therein. In contrast, in a topological map, the landmarks together with the extracted feature servers as nodes in a graph and the adjacency information reflects the geometric relations between each node. In an existing solution, a detailed grid map is first acquired using a vehicle equipped inertial navigation system and multiple laser range finders, and then a vehicle-mounted LiDAR sensor is used to localize the vehicle relative to the obtained map using a particle filter. In this work, the map is a fixed representation of the environment at each time instance. To achieve robust localization, maps are regarded as probability distributions over environments in each cell. The accuracy of these methods exceeds that of GPS-based method by over an order of magnitude.

In another existing solution, a LiDAR is used to obtain a pre-mapped environment, from which landmarks are extracted. When a vehicle transverses the environment, landmarks extracted from vehicle-mounted sensors are used to associate with the LiDAR landmarks and further obtain the vehicle locations. LiDAR is widely used in many other works and show great capability in measuring the ranges of targets in the environment. However, it is weak in recognizing targets, which is one of the strong points of computer vision. Thus, in many other works, cameras are adopted to localize vehicles. In another existing solution, a single monocular camera is used to conduct ego localization. The camera image is used to estimate the ego position relative to a visual map previously computed. However, cameras cannot provide high-quality range information and their performances are influenced by light and weather. Hence, both LiDAR and RGB-Depth camera are used to do localization by incorporating visual tracking algorithms, depth information of the structured light sensor, and a low-level vision-LiDAR fusion algorithm. IMU, camera and LiDAR may also be fused to realize three-dimensional localization. In some works, the measurements need not to be explicitly associated with the landmarks stored in the map. However, in many other works, data association (matching), the process of associating a measurement or feature when a vehicle transverses the environment to its corresponding previously extracted feature, is important. Pearson product-moment correlation may be used to perform the data association. In visual images, Sum of Square Differences (SSD) and Normalized Cross Correlation (NCC) are traditional similarity measures that use the intensities differences between corresponding pixels in two image patches.

### SUMMARY

According to a first aspect, a method for determining a position of a vehicle is provided. The method comprises the following steps: In a first step, a reference map is provided. The reference map comprises segmentations of a reference image with landmarks. In a second step, a measurement image of a vehicle environment are captured. In a third step, segmentations of the measurement image and neighborhood graphs are determined to obtain a measurement map, wherein a segmentation is represented by a vertex and where a neighborhood graph comprises the vertex and edges containing information to identify neighboring vertices of the vertex. In a fourth step, segmentations of the reference image are compared with the segmentations represented by the vertices of the measurement image and the neighborhood graphs and segmentations contained in the reference image and in measurement image are determined. In a fifth step, estimating the vehicle's position with reference to the reference map during its movement along a road based on a result of the comparison is carried out.

According to a second aspect, a computer program element for determining a position of a vehicle is provided. The computer program element, when running on a processing unit, causes the processing unit to carry out the abovementioned method for determining a position of a vehicle.

According to a third aspect, a computer program element for determining matching landmark objects is provided. The computer program element includes: a landmark map network part and measurement map part; each of the landmark map network part and measurement map part comprising: an object selection module configured to select an object from a set of objects contained in an image; a Resnet configured to extract features from a first segmentation of the selected object and providing the extracted features to a common PointNet, a PointNet configured to extract features from a first LiDAR point cloud of the selected object and providing the extracted features to the common PointNet, a second Resnet configured to extract features from neighbor segmentations of the first segmentation and providing the extracted features to a GAT, a second PointNet configured to extract features from LiDAR points cloud of the neighboring object of the selected object and providing the extracted features to a GAT, the GAT, configured to describe the extracted features containing spatial information, and to provide the described landmark map features to the common PointNet; the common PointNet configured to concatenate the extracted features from the first ResNet, the first PointNet and the GAT and to determine a similarity between the features of the object of the landmark map network part and the features of the object of the measurement map part.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the embodiment. In the following description, various embodiments are described with reference to the following drawings, in which:

FIG. 1 shows an example of the three coordinate systems in the localization framework, according to an embodiment;

FIG. 2 shows an example of a localization coordinate system, according to an embodiment;

FIG. 3 shows an example of a sensor setup on a probe vehicle according to an embodiment;

FIG. 4 shows an example of a sensor setup on a probe vehicle according to an embodiment;

FIGS. 5A and 5B show an example of images captured in a time step, according to an embodiment;

FIG. 6 shows an example of segmentations obtained based on the camera image of FIG. 5A, according to an embodiment;

FIG. 7 shows an example of a landmark map, according to an embodiment;

FIG. 8 shows a graph topological measurement map constructed at time t and examples of vertices in the measurement graph, according to an embodiment;

FIG. 9 shows a rough localization obtained using GPS data, according to an embodiment;

FIG. 10 shows a process flow diagram of a Landmark Objects Matching Neural Network (LOMNN) according to an embodiment;

FIG. 11 shows graphs that measure the performance of the LOMNN, according to an embodiment;

FIG. 12 shows a process flow diagram of a Localization Neural Network according to an embodiment;

FIG. 13 shows a process flow diagram of a Localization Neural Network according to an embodiment;

FIG. 14 shows artificial datasets generated by the CARLA simulator, according to an embodiment;

FIG. 15 shows the test results testing the LNN using the first CARLA dataset, according to an embodiment;

FIG. 16 shows the test results of testing the LNN using a real dataset, according to an embodiment;

FIG. 17 is a flowchart illustrating a method for determining a position of a vehicle according to an embodiment; and

FIG. 18 is a flowchart illustrating a diagram of a localization framework according to an embodiment.

### DETAILED DESCRIPTION OF EMBODIMENTS

Embodiments described below in context of the devices are analogously valid for the respective methods, and vice versa. Furthermore, it will be understood that the embodiments described below may be combined, for example, a part of one embodiment may be combined with a part of another embodiment.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The described embodiments similarly pertain to the method for determining a position of a vehicle, to the computer program element for determining a position of a vehicle, to the computer program element for determining matching landmark objects, and the computer readable medium. Synergetic effects may arise from different combinations of the embodiments although they might not be described in detail.

In this context, the device as described in this description may include a memory which is for example used in the processing carried out in the device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In order that the aspects of the present application may be readily understood and put into practical effect, various embodiments will now be described by way of examples and not limitations, and with reference to the figures.

High-accuracy vehicle self-localization is essential for path planning and vehicle safety in autonomous driving. As such, there may be a desire to improve position determination for autonomous driving.

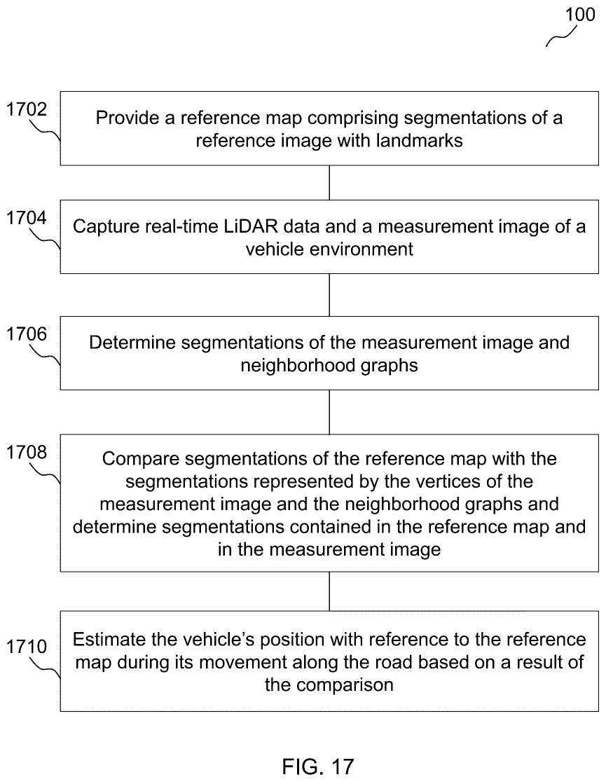

According to various embodiments, a method for determining a position of a vehicle is provided. The method for determining position of the vehicle may also be referred herein as the method 100, which is illustrated as a flow diagram in FIG. 17. The vehicle may also be referred herein as the ego vehicle. The vehicle may be an autonomous vehicle.

The method 100 may include providing a reference map that includes landmarks from the environment. These landmarks may be useful for the vehicle to localize itself. The map may be generated off-line using static roadside objects such as traffic lights, traffic signs and poles, and these objects are specifically organized in a graph topology for calibration. The reference map may be also referred herein as calibration landmark map.

The method 100 may be performed by a localization framework that employs deep learning techniques to perform automatic feature extraction from sensors' measurements. The localization framework may include a Convolutional Neural Network (CNN) based network to extract features from visual images captured by the vehicle's camera and may include a Graph Convolutional Network (GCN) to integrate measurements from other sensors onboard the vehicle, e.g. LiDAR. The localization framework may estimate the vehicle's location by comparing the extracted features from the equipped sensors' real-time measurements and the calibration landmark map.

The method 100 may include various processes, including:
(a) constructing a graph topological landmark map for calibration;
(b) extracting features from camera images using a feature extraction neural network, such as CNN;
(c) integrating measurement data obtained from other sensor data (LiDAR) using a further network, such as GCN;
(d) comparing extracted features and the calibration landmark map using a recurrent neural network (RNN); and
(e) estimating the vehicle's location based on the comparison, during its movement along the road.

In comparing the extracted features and the calibration landmark map, a matching neural network based on Graph Attention Networks may be used to perform data association to find matching landmark objects in the extract features and the calibration landmark map.

The method 100 may achieve highly accurate, for example to centimeter accuracy, and precise localization while being robust to changes in the environment, for example, variable traffic flows and different weather conditions.

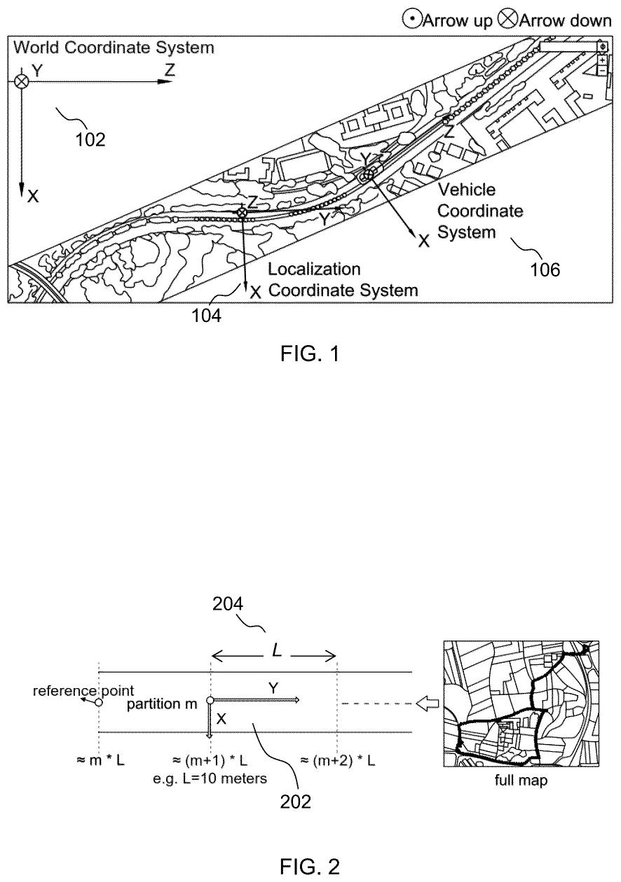

An implementation of the method 100 is described in the following paragraphs, with respect to FIGS. 1 to 13.

FIG. 1 shows an example of the three coordinate systems in the localization framework, according to various embodiments. The three coordinate systems include (i) the world coordinate system 102, (ii) the localization coordinate system 104 and (iii) the vehicle coordinate system 106. The world coordinate system 102 can be set as an Earth global surface coordinate system like the Universal Transverse Mercator (UTM) or even some self-defined coordinate systems in a city. In the following example, the UTM is used for the world coordinate system 102.

FIG. 2 shows an example of the localization coordinate system 104. The z-axis is left out of the figure for simplicity. The targeted roads are separated into M partitions 202, and each road partition 202 has a reference point as the origin together with a local coordinate system, also referred herein as the localization coordinate system 104. Each partition 202 roughly has length L, also referred herein as the partition length 204, along a road. The output of the localization framework is a position in the localization coordinate system 104 of the relevant road partition m, m=1, 2, . . . , M, that the ego-vehicle is currently in. Positions from an earth-fixed localization coordinate system 104 may be transformed to a position in a world coordinate system 102. Beside these two external coordinate systems, the vehicle itself has a coordinate system which is named as the vehicle coordinate system 106. Sensors equipped in the ego vehicle may refer to the vehicle coordinate system 106.

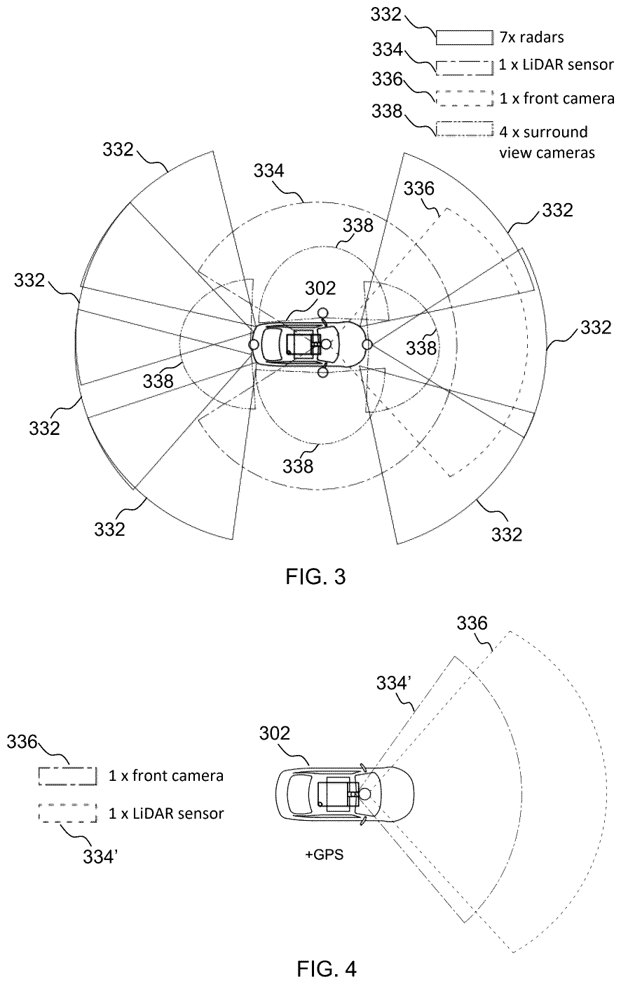

FIG. 3 shows an example of a sensor setup on a probe vehicle 302 according to various embodiments. The method 100 may include providing a reference map, also referred herein as landmark calibration map. The reference map may be generated based on sensor collected from a calibration run on target roads using the probe vehicle 302. The probe vehicle 302 may be equipped with sensors for acquiring environmental data. The sensors may include cameras, radar, and a LiDAR, like the sensor setup of an autonomous vehicle. In this example, the probe vehicle 302 is equipped with seven radars, one LiDAR sensor, one front camera and four surround view cameras. The field-of-views (FOV) of the respective sensors are indicated as areas within lines 332, 334, 336 and 338, and their FOVs at least partially overlap. The radar sensor is Advanced Radar System (ARS) 430 from Continental Automotive, which is a 77 GHZ radar sensor with digital beam-forming scanning antenna which offers two independent scans for far and near range. Four of the seven radars are positioned at the rear of the probe vehicle while three are positioned at the front of the vehicle. The FOVs of the radars are represented by the lines 332. The LiDAR sensor is VLP 32 from Velodyne, which is a long-range three-dimensional LiDAR sensor. The LiDAR may be slightly titled to the front of the probe vehicle, thereby resulting in a blind spot behind the probe vehicle. The FOV of the LiDAR is represented by the line 334. The front camera is positioned next to the LiDAR sensor and is a Blackfly front camera. The FOV of the front camera is represented by the line 336. The surround view cameras are SVC 215 or 220 from Continental Automotive. The FOVs of the surround view cameras is represented by the lines 338.

FIG. 4 shows a partial FOV of the LiDAR sensor (as indicated by line 334′) and the FOV of the front camera (as indicated by line 336), according to the example shown in FIG. 3. The FOVs of the LiDAR sensor and the front camera may overlap.

From the sensor data collected in the calibration run on the target roads, data points collected by the LiDAR sensor may be mapped to images captured by the front camera, using the vehicle coordinate system at each time step. In other words, only LiDAR points that overlap with the FOV of the front camera are used, as shown in FIG. 4. The term “frame” is used herein to denote the images and the LiDAR points collected at each time step.

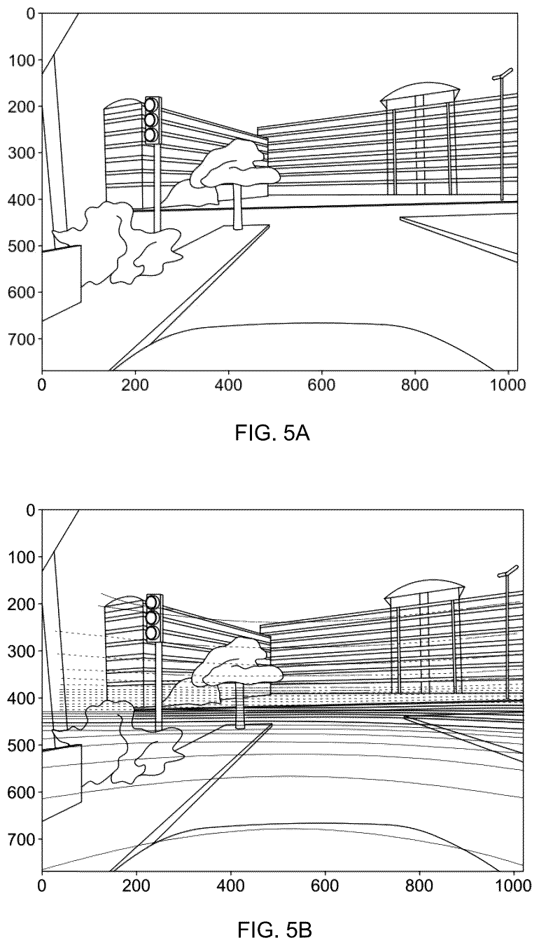

FIGS. 5A and 5B show an example of images captured in a time step, according to various embodiments. FIG. 5A illustrates an original image captured by the front camera at a certain time step and FIG. 5B illustrates the visualization of the LiDAR points mapping onto the front camera image.

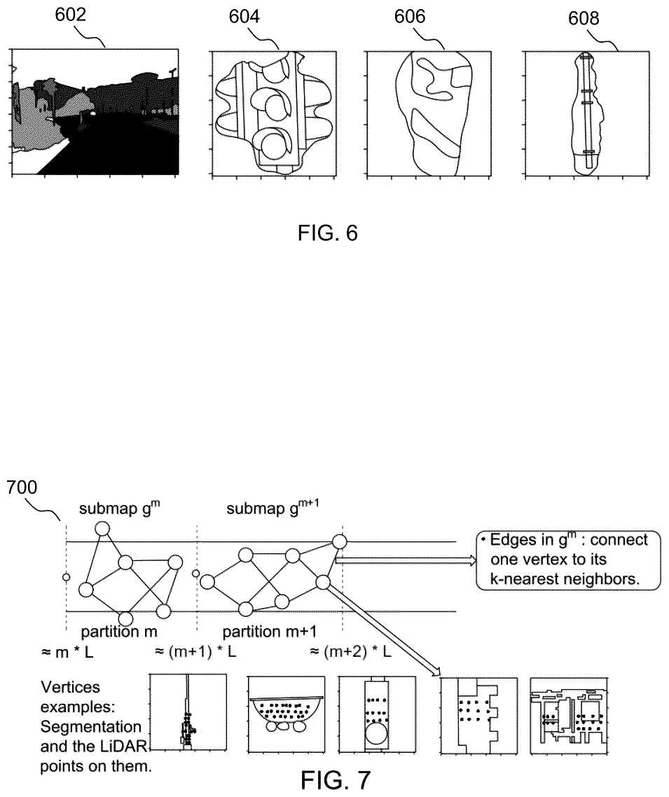

To generate the reference map, objects that will be used as vertices may be identified. To this end, images captured by the front camera may be input to a semantic segmentation neural network. The semantic segmentation neural network may output semantic segmentation, for example, the image 602 in FIG. 6, based on the input data. An example of the semantic segmentation neural network may be based on the DeepLabV3 architecture, as disclosed in “Rethinking atrous convolution for semantic image segmentation” by Chen et. al., arXiv preprint arXiv:1706.05587, 2017, herein incorporated by reference. The semantic segmentation neural network model may be trained on the Cityscapes dataset, as disclosed in “The cityscapes dataset for semantic urban scene understanding” by Cordts et. al., in Proceedings of the IEEE conference on computer vision and pattern recognition, 2016, pp. 3213-3223.

FIG. 6 shows an example of segmentations obtained based on the camera image of FIG. 5A. The image 602 is an example of semantic segmentation based on the camera image of FIG. 5A. The images 604, 606 and 608 are examples of cropped instance segmentations, obtained from the camera image of FIG. 5A and the semantic segmentation, in this case, the image 602. The cropped instance segmentations may be obtained from the image 602 by cropping the input image based on image plane coordinates of objects in the semantic segmentation image 602. The cropped instance segmentations may be resized to, as an example, 256×256 pixels with paddings. The static roadside objects, including traffic lights, traffic signs, poles, road edges, and building windows, may be utilized in the localization framework, while dynamic objects such as vehicles, may be discarded. The dynamic objects are not useful for the localization framework, since their positions are likely to change in the next frame, or next run on the target roads.

In the following, details of the localization framework are described. The key notations are summarized in the following table:

| Notations | Explanations |
|---|---|
| L | The partition length for a road. |
| m | The index of road partition where m = 1, 2 , . . . , M. |
| [symbol] = (V^{m}, E^{m}) | A graph topological landmark map for calibration in the road partition m. |
| | where V [symbol] is the set of vertices and E [symbol] is the set of edges of this map. |
| s^{m,} [symbol] | The jth (j ∈ [symbol] ) landmark segmentation in the road partition m. |
| p [symbol] m [symbol] | The points cloud reflected from the landmark segmentation s^{m} [symbol] ^{.} |
| a [symbol] = (s^{m} [symbol] pₛm [symbol] ) | The j-th landmark object in the road partition m. |
| ${𝒢}_{i}^{x} = ( {V}_{i}^{x} , {E}_{i}^{x} )$ | A measurement map based on the x-th frame collected at the time step t, |
| | where Vₜⁿ is the set of vertices and E [symbol] is the set of edges of this map. |
| $s \text{?}$ | The i-th (i ∈ [symbol] ) landmark segmentation in the x-th frame collected at the time step t. |
| $p \text{?}$ | $The points cloud reflected from the landmark segmentation s \text{?}$ |
| $d \text{?} = ( s \text{?} , p \text{?} )$ | The i-th landmark object in the x-th frame collected at the time step t. |
| $𝒢 \text{?} = ( V \text{?} , E \text{?} )$ | $A neighborhood map with respect to i - th landmark segmentation in the measurement 𝒢 \text{?}$ |
| | $of the x - th frame collected at the time step t , where {V}_{t} \text{?} is the set of vertices and E \text{?} is$ |
| | the set of edges of this map. |
| $𝒢 \text{?}$ | Two sub-graphs containing the common landmark objects in [symbol] [symbol] and [symbol] [symbol] respectively |
| $s \text{?} , s \text{?}$ | The i-th (i ∈ [symbol] ) pair of matched landmark segmentations in [symbol] [symbol] and [symbol] [symbol] respectively, |
| $p \text{?} , p \text{?}$ | The matched points clouds reflected from the landmark segmentation s [symbol] and s [symbol] respectively. |
| $d \text{?} = ( s \text{?} , p \text{?} )$ | The i-th (i ∈ [symbol] ) pair of matched landmark objects in [symbol] [symbol] and [symbol] [symbol] respectively |

$d \text{?} = ( s \text{?} , p \text{?} ) ,$

| | |
|---|---|
| R( · ) | Resnet used to extract features from landmark segmentations. |
| P( · ) | PointNet used to extract features from points clouds. |
| f( · ) | It is used to concatenate features from landmark segmentations and points clouds, in other words, |
| | it is used to extract features for landmark objects. |
| g( · ) | GAT used to extract features for the graph structured data with vertices and edges. |

[symbol]

indicates data missing or illegible when filed

The cropped instance segmentations are referred herein as landmark segmentations, if they contain snapshots of static roadside objects. Each landmark segmentation in a road partition m may be denoted as s^{m,j}(j∈N⁺). The point clouds reflected from the landmark segmentations s^{m,j} may be denoted as

$${p}_{{s}^{m , j}} .$$

The point clouds

$${p}_{{s}^{m , j}}$$

maybe obtained from the LiDAR points mapping (such as in FIG. 5B) and the pixel positions where the landmark segmentations are in the original camera images (such as in FIG. 5A).

The tuple

$${d}^{m , j} = ( {s}^{m , j} , {p}_{{s}^{m , j}} )$$

is referred herein as a landmark object in the road partition m, if s^{m,j} is a landmark segmentation of the road partition m. A set of N landmark objects in the road partition m may be denoted as

$${\{ {d}^{m , j} \}}_{j = 1}^{N} = \{ {d}^{m , 1} , … , {d}^{m , N} \} .$$

A set of objects with an arbitrary number of landmark objects rather than N, may be denoted as {d^{m,j}}ⱼ.

The method 100 may further include constructing a graph topological landmark map G^{m}=(V^{m}, E^{m}) for calibration in each partition m, where m=1, 2, . . . , M. V^{m} is the set of vertices and E^{m} is the set of edges. The vertices set V^{m}={d^{m,j})}ⱼ contains the static roadside landmark objects in each partition m. One vertex in V^{m} is connected to the other vertices as its neighbours, if and only if, they are among the k nearest vertices to the vertex. Here, the coordinate of object d^{m,j} in 3D space is computed by taking the average of all LiDAR points

$$\frac{{\sum }_{q ∈ {p}_{{s}^{m , j}}} q}{\vert {p}_{{s}^{m , j}} \vert}$$

where |Pₛ_{^{m,j}}| is the cardinality of

$${p}_{{s}^{m , j}} ,$$

and the distance between two objects is measured by the Euclidean distance, L₂ norm.

FIG. 7 shows an example of a landmark map 700. For simplicity, the landmark map 700 is constructed by using the static objects from the frame collected at the reference point in each road partition. The map quality may be improved by integrating objects from all frames collected in each partition. In this regard, the landmark map is denoted as

$$G = {\{ {G}^{m} \}}_{m = 1}^{M} .$$

The landmark map 700 may include a plurality of submaps. Each submap may correspond to a respective partition. Each submap may include a plurality of vertices and a plurality of edges. Each vertex may correspond to a respective landmark segmentation. Each edge may connect two vertices. The method 100 for determining a position of a vehicle may further include performing a localization process, which may be performed in real-time. The localization process may include constructing a measurement map based on sensor data that may be captured and received in real-time. The sensor data may be captured by sensors on the vehicle for whom the positioned is to be determined. This vehicle is also referred herein as the ego vehicle. The ego vehicle may be a different vehicle from the probe vehicle 300. Similar to the steps described above in relation to the landmark map construction, the measurement map

$${G}_{t}^{x} = ( {V}_{t}^{x} , {E}_{t}^{x} )$$

may be constructed based on the frame collected at the time step t using the static roadside objects obtained from the image processed by the segmentation neural network and the LiDAR points. A vertex in

$${G}_{t}^{x}$$

may be connected to the other neighboring vertices if and only if they are among the k nearest vertices to the vertex.

The method 100 may further include performing a rough localization to determine which

$${G}_{t}^{y}$$

∈G of the landmark map graph that the ego vehicle is currently in. For simplicity the GPS measured at each time step t may be used to determine the rough location of the ego vehicle. Alternatively, other techniques such as extended Kalman filter and image matching may be used to perform the rough localization.

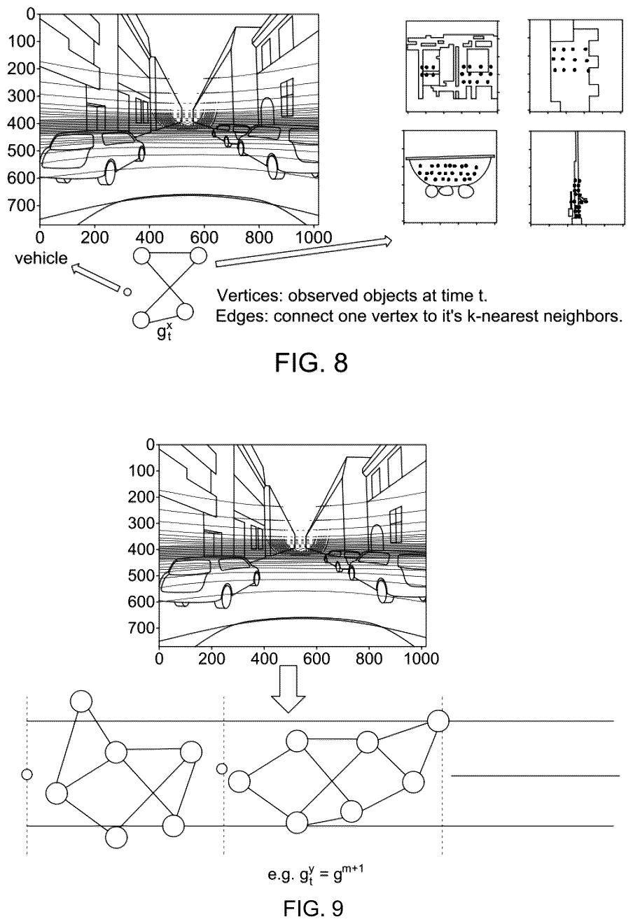

FIG. 8 shows a graph topological measurement map

$${𝒢}_{t}^{x}$$

constructed at time t and examples of vertices in the measurement graph.

FIG. 9 shows a rough localization obtained using GPS data. If the rough location obtained by GPS or other means, at the time step t shows that the ego vehicle is in road partition m+1, then

$${G}_{t}^{y} = {G}^{m + 1} .$$

Next, the localization process may include identifying landmark objects that are common to the landmark map graph

$${G}_{t}^{y}$$

and the measurement graph

$${G}_{t}^{x} .$$

Landmark objects

$${d}_{t}^{x , i} = ( {s}_{t}^{x , i} , {p}_{{s}_{t}^{x , i}} ) ∈ {V}_{t}^{x} and {d}_{t}^{y , i} = ( {s}_{t}^{y , i} , {p}_{{s}_{t}^{y , i}} ) ∈ {V}_{t}^{y}$$

are considered to be common between the two graphs, if

$${s}_{t}^{x , i} and {s}_{t}^{y , i}$$

are snapshots of the same static roadside object.

Identifying these common landmark objects may include matching the vertices in the measurement map

$${G}_{t}^{x} = ( {V}_{t}^{x} , {E}_{t}^{x} )$$

and the landmark map graph

$${G}_{t}^{y} = ( {V}_{t}^{y} , {E}_{t}^{y} )$$

using a Landmark Objects Matching Neural Network (LOMNN). The vertices in the measurement map

$${G}_{t}^{x}$$

may contain different objects from those in the landmark map graph

$${G}_{t}^{y}$$

The representation

$${d}_{t}^{x , i} and {d}_{t}^{y , i}$$

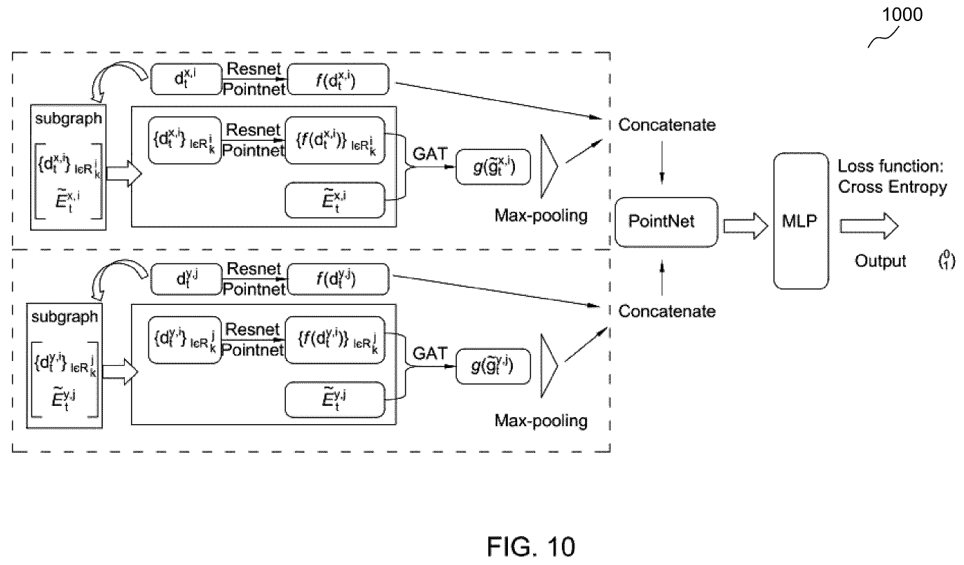

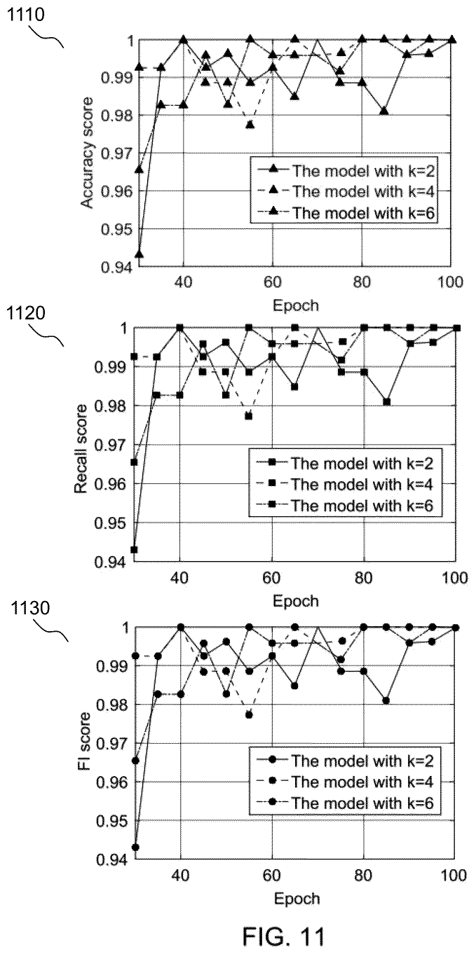

may be different even if they are from the same static roadside object, since the data are collected from different locations under different road conditions. The LOMNN is described further with respect to FIGS. 10 and 11.

When the matched pairs of landmark objects are found, the common landmark objects in two different graphs are extracted. Two sub-graphs containing the common landmark objects may be constructed. The sub-graphs are denoted as

$${G}_{t , match}^{x} and {G}_{t , match}^{y}$$

respectively. Different from the conventional matching methods for images, the method 100 may not only exploit the images of landmark segmentations but also make full use of the LiDAR points on these segmentations.

The localization process may further include extracting features from the common landmark objects and comparing the extracted features using a Localization Neural Network (LNN) to perform localization regression. The LNN may compare the real-time measured data to the calibration landmark map, also referred herein as landmark map or reference map. The sub-graphs

$${G}_{t , match}^{x} and {G}_{t , match}^{y}$$

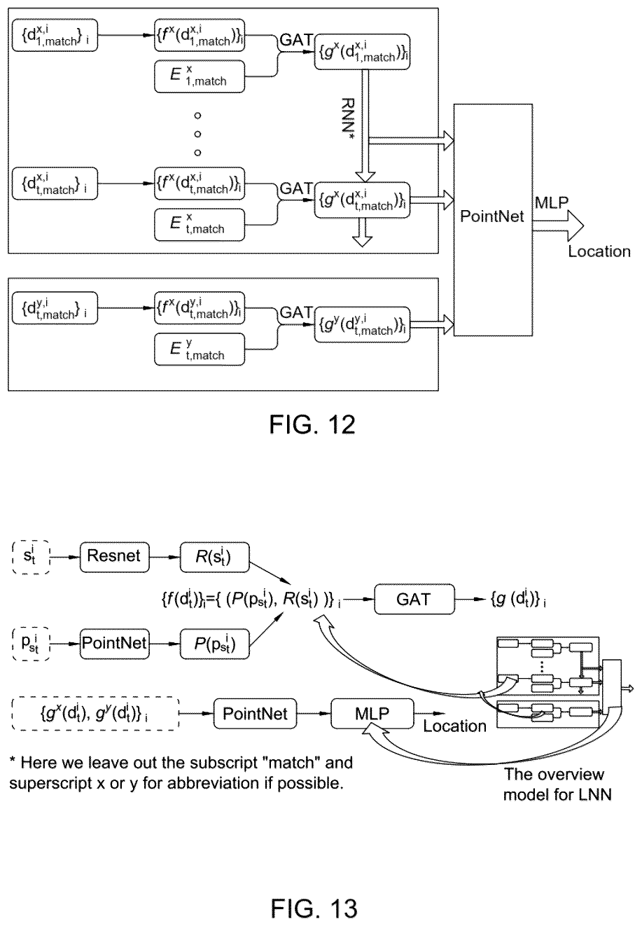

may be input to the LNN. The LNN may output an estimated location of the ego vehicle with respect to the localization coordinate system in each road partition. The LNN is described further with respect to FIGS. 12 and 13.

FIG. 10 shows a process flow diagram of the LOMNN according to various embodiments. The LOMNN may be a trained network that is configured to perform a landmark object matching process 1000. The landmark object matching process 1000 determines whether a given pair of landmark objects can be regarded as the same. The LOMNN may label a pair of landmark objects with a matched label “1” if the LOMNN determines them to be matching. The LOMNN may label a pair of landmark objects with a mismatched label “0” if the LOMNN determines them to be mismatched. The LOMNN may include three kinds of neural networks, namely Resnet, GAT and PointNet. The Resnet may be configured to extract features from the images. The GAT may be configured to perform subgraph feature description. The PointNet may be configured to compare features.

In a first step, features of landmark objects are extracted. Two landmark objects

$${d}_{t}^{x , i} = ( {s}_{t}^{x , i} , {p}_{{s}_{t}^{x , i}} ) and {d}_{t}^{y , j} = ( {s}_{t}^{y , j} , {p}_{{s}_{t}^{y , j}} )$$

may be chosen arbitrarily from

$${G}_{t}^{x} and {G}_{t}^{y} .$$

Then, the Resnets and PointNets may be used to extract the features of

$${d}_{t}^{x , i} and {d}_{t}^{y , j} .$$

In particular, similar to the conventional image processing methods based on neural networks, the Resnets may be adopted to extract the high dimensional features for the landmark segmentations

$${s}_{t}^{x , i} and {s}_{t}^{y , j} ,$$

whose outputs are denoted by

$$R ( {s}_{t}^{x , i} ) and R ( {s}_{t}^{y , j} ) .$$

Meanwhile, the PointNets may be exploited to handle the corresponding LiDAR points cloud

$${p}_{{s}_{t}^{x , i}} and {p}_{{s}_{t}^{y , j}} ,$$

whose outputs are denoted by

$$P ( {p}_{{s}_{t}^{x , i}} ) and P ( {p}_{{s}_{t}^{y , j}} ) .$$

Thus, the extracted concatenated features of

$${d}_{t}^{x , i} and {d}_{t}^{y , j}$$

are denoted by

$$f ( {d}_{t}^{x , i} ) and f ( {d}_{t}^{y , j} )$$

respectively, where

$$f ( {d}_{t}^{x , i} ) = ( R ( {s}_{t}^{x , i} ) ‖ P ( {p}_{{s}_{t}^{x , i}} ) )$$

$$and$$

$$f ( {d}_{t}^{y , j} ) = ( R ( {s}_{t}^{x , i} ) ‖ P ( {p}_{{s}_{t}^{y , j}} ) ) ,$$

where “∥” denotes the concatenation operation.

In a second step, the GAT may be used to determine feature description. With respect to the landmark objects

$${d}_{t}^{x , i} = ( {s}_{t}^{x , i} , {p}_{{s}_{t}^{x , i}} ) and {d}_{t}^{y , j} = ( {s}_{t}^{y , j} , {p}_{{s}_{t}^{y , j}} ) ,$$

the corresponding neighborhood maps denoted by

$${\tilde{G}}_{t}^{x , i} = ( {\tilde{V}}_{t}^{x , i} , {\tilde{E}}_{t}^{x , i} ) and {\tilde{G}}_{t}^{y , j} = ( {\tilde{V}}_{t}^{y , j} , {\tilde{E}}_{t}^{y , j} )$$

may be constructed, where

$${\tilde{V}}_{t}^{x , i} and {\tilde{V}}_{t}^{y , j}$$

are the set of vertices, while

$${\tilde{E}}_{t}^{x , i} and {\tilde{E}}_{t}^{y , j}$$

are the set of edges. Specifically,

$${\tilde{V}}_{t}^{x , i}$$

includes the k nearest landmark objects

$${\{ {d}_{t}^{x , l} \}}_{l ∈ {R}_{k}^{i}}$$

to the

$${d}_{t}^{x , i}$$

(which is regarded as the i-th vertex in

$${G}_{t}^{x , i} ) .$$

$${\tilde{E}}_{t}^{x , i}$$

denotes the corresponding connection relationships matrix for these landmark objects.

$${R}_{k}^{i}$$

denotes the set of subscripts of k nearest vertices to the i-th vertex in

$${G}_{t}^{x , i} .$$

### Similarly,

$${\tilde{V}}_{t}^{y , j} and {\tilde{E}}_{t}^{y , j}$$

are the notations like

$${\tilde{V}}_{t}^{x , i} and {\tilde{E}}_{t}^{x , i} .$$

Then, the landmark objects in in the corresponding neighborhood maps

$${\tilde{G}}_{t}^{x , i} and {\tilde{G}}_{t}^{y , j}$$

may be processed by Resnets and PointNets to extract the corresponding features.

The feature extraction process may include processing the landmark segmentations in

$${\tilde{G}}_{t}^{x , i} and {\tilde{G}}_{t}^{y , j}$$

by Resnets while the corresponding LiDAR point clouds may be processed PointNets. Furthermore, the features of landmark objects and the corresponding connection relationship matrices in the

$${\tilde{G}}_{t}^{x , i} and {\tilde{G}}_{t}^{y , j}$$

may be handled by GAT to describe their features containing spatial information. Specifically, taking the graph

$${\tilde{G}}_{t}^{x , i}$$

as an example, the attention mechanism of graph attentional layer with respect to the pair of vertices (u, v) is described as

$${ξ}_{u v} = \frac{exp ( LeakyReLU ( {a}^{T} [ W \times f ( {d}_{t}^{x , u} ) ‖ W \times f ( {d}_{t}^{x , v} ) ] ) )}{{\sum }_{l ∈ {R}_{k}^{i}} exp ( LeakyReLU ( aT [ W \times f ( {d}_{t}^{x ,} ) ‖ W \times f ( {d}_{t}^{x , l} ) ] ) )} , ( u , v ∈ {R}_{k}^{i} ) ,$$

where (⋅)^{T} denotes transposition, ∥ is the concatenation operation, ξᵤᵥ is the attention coefficient of vertex v to u, W denotes the weight matrix for each vertex, and a is the weight vector. LeakyReLU nonlinearity may be used here.

When the multi-head attention is considered, that is, M independent attention mechanisms are used to stabilize the learning process, the output features of each vertex (after applying a nonlinearity σ) are given by:

$${f}^{′} ( {d}_{t}^{x , u} ) = {‖}_{r = 1}^{M} σ ( {\sum }_{v ∈ {R}_{k}^{i}} {ξ}_{u v}^{r} \times {W}^{r} \times f ( {d}_{t}^{x , v} ) ) ,$$

the output of the final (prediction) layer may be described as

$${f}^{′} ( {d}_{t}^{x , u} ) = σ ( \frac{1}{M} {\sum }_{r = 1}^{M} {\sum }_{v ∈ {R}_{k}^{i}} {ξ}_{u v}^{r} \times {W}^{r} \times f ( {d}_{t}^{x , v} ) ) .$$

The whole output from the GAT, namely

$$g ( {\tilde{G}}_{t}^{x , i} ) ,$$

may include all

$${f}^{′} ( {d}_{t}^{x , u} ) ( u ∈ {R}_{k}^{i} ) .$$

In a third step, outputs from the previous two steps may be concatenated as the inputs for the PointNet, as the similarity measure for the feature comparison. Multi-Layer Perceptron (MLP) may be introduced to output the predicted labels, where the loss function is the cross-entropy loss,

$${L}_{ce} ( α , \hat{α} ) = - {\sum }_{i} {α}^{( i )} log {\hat{α}}^{( i )} + ( 1 - {α}^{( i )} ) log ( 1 - {\hat{α}}^{( i )} ) ,$$

in which α⁽ⁱ⁾ denotes the true label and \hat{α}⁽ⁱ⁾ denotes the predicted label.

In a fourth step, a matched sub-graph may be constructed. After identifying the common landmark objects in the landmark map graph and the measurement graph, two sub-graphs containing the common landmark objects may be generated. The two sub-graphs may be denoted as

$${G}_{t , match}^{x} and {G}_{t , match}^{y}$$

respectively. In

$${G}_{t , match}^{x} ,$$

two vertices are connected to each other if and only if the two vertices are connected to each other in

$${G}_{t}^{x} .$$

### Similarly, in

$${G}_{t , match}^{y} ,$$

two vertices are connected to each other if and only if the two vertices are connected to each other in

$${G}_{t}^{y} .$$

Experiments were carried out to evaluate the performance of the LOMNN. Real sensor data from Continental Automotive Pte Ltd was used to train and test the model. The sensor data captured landmark segmentations including traffic lights, traffic signs and lamp posts, for which there were also LiDAR points. About 5,000 pairs of segmentations were used, in which 80% pairs with labels are training data and 20% pairs are testing data. In the training process, there are 100 epochs for the model to reveal the corresponding matching performance. Accuracy score, Recall score and FI score are considered to show the matching performance. In addition, different number for k nearest neighbors in neighborhood maps are also chosen in the proposed model so that it can be evaluated if number k has great impact on the matching performance.

FIG. 11 shows graphs 1110, 1120 and 1130 that measure the performance of the LOMNN. The graph 1110 shows the accuracy score of the output of the LOMNN as a function of the number of epochs, for k=2, k=4, and k=6. The graph 1120 shows the recall score of the output of the LOMNN as a function of the number of epochs, for k=2, k=4, and k=6. The graph 1130 shows the FI score of the output of the LOMNN as a function of the number of epochs, for k=2, k=4, and k=6. The graphs show that the LOMNN can achieve over 98% for each of accuracy, recall and FI scores after training for more than 40 epochs. Also, the different values of k, i.e. the number of neighbors, did not result in substantial changes in the performance of the LOMNN.

FIG. 12 shows a process flow diagram of the LNN according to various embodiments. The LNN may first use a first extraction network f^{x}(⋅) and a second extraction network f^{y}(⋅) to extract features of landmark objects

$${d}_{t , match}^{x , i} = ( {s}_{t , match}^{x , i} , {p}_{{s}_{t , match}^{x , i}} ) and {d}_{t , match}^{y , i} = ( {s}_{t , match}^{y , i} , {p}_{{s}_{t , match}^{y , i}} ) and$$

$${G}_{t , match}^{x} and {G}_{t , match}^{y}$$

respectively. f^{x}(⋅) and f^{y}(⋅) may have the same network architecture but separate trainable parameters, which is depicted in FIGS. 12 and 13. Similar to the LOMNN operation shown in FIG. 10, Resnets R^{x}(⋅) and R^{y}(⋅) may be used to extract features from the common landmark segmentations. Additionally, PointNets P^{x}(⋅) and P^{y} may extract features from

$${p}_{{s}_{t , match}^{x , i}} and {p}_{{s}_{t , match}^{y , i}} .$$

The PointNets may be useful for reasoning about unordered data (e.g. LiDAR points) with arbitrary numbers, at least partly due to the max-pooling operator in PointNet.

The Graph Attention Networks (GAT) is represented by g^{x}(⋅) and g^{y}(⋅). Like f^{x}(⋅) and f^{y}(⋅), g^{x}(⋅) and g^{y}(⋅) may have the same network architecture but separate trainable parameters/g^{x}(⋅) may further extract features

$${g}^{x} ( {d}_{t , match}^{x , i} )$$

for each landmark object from the graph structured data with

$${\{ {f}^{x} ( {d}_{t , match}^{x , i} ) \}}_{i} and {E}_{t , match}^{x} ,$$

where

$${f}^{x} ( {d}_{t , match}^{x , i} ) = ( {R}^{x} ( {s}_{t , match}^{x , i} ) \vert \vert {P}^{x} ( {p}_{{s}_{t , match}^{x , i}} ) )$$

is the concatenated features of vertex i, and ∥ denotes the concatenation operation. The similar operation may be performed by g^{xy}(⋅) on

$${\{ {f}^{y} ( {d}_{t , match}^{y , i} ) \}}_{i} and {E}_{t , match}^{y} .$$

The LNN may optionally further include a Recurrent Neural Network (RNN), such as a long-short-term memory (LSTM). The RNN may receive the output of the GAT and may perform learning from measurements history

$${\{ {G}_{t}^{x} \}}_{{t}^{′} = 1}^{t - 1}$$

during the driving time. The RNN may improve the performance of the LNN through the learning from the historical data, as compared to when the LNN uses only the current collected data at time t.

A new PointNet may then perform a comparison for the extracted features from the pairs of common landmark objects. A multilayer perceptron (MLP) may be applied to perform the neural network regression using the output of the final features from this PointNet.

The loss function of the LNN may be the Huber loss function:

$${L}_{δ} ( g , \hat{g} ) = \{ \begin{matrix}\frac{1}{2} {‖ g - \hat{g} ‖}_{2}^{2} if {‖ g - \hat{g} ‖}_{2} < δ , \\ δ {‖ g - \hat{g} ‖}_{1} - \frac{1}{2} {δ}^{2} otherwise ,\end{matrix}$$

where g is the ground truth location and g is the model output. During the training of the LNN, the ground truth matching of objects may be intentionally perturbed with small probability (less than 0.1), which makes the test result more promising.

Experiments were conducted using the LNN to validate its performance. For the experiments, the RNN was excluded for simplicity. The experimental results will be described in the following paragraphs.

The LNN was evaluated using two artificial datasets generated by the CARLA simulator and a real dataset provided by Continental Automotive Pte. Ltd. The CARLA simulator is disclosed in “CARLA: An open urban driving simulator” by Dosovitskiy et. al. in Proceedings of the 1st Annual Conference on Robot Learning, 2017, pp. 1-16.

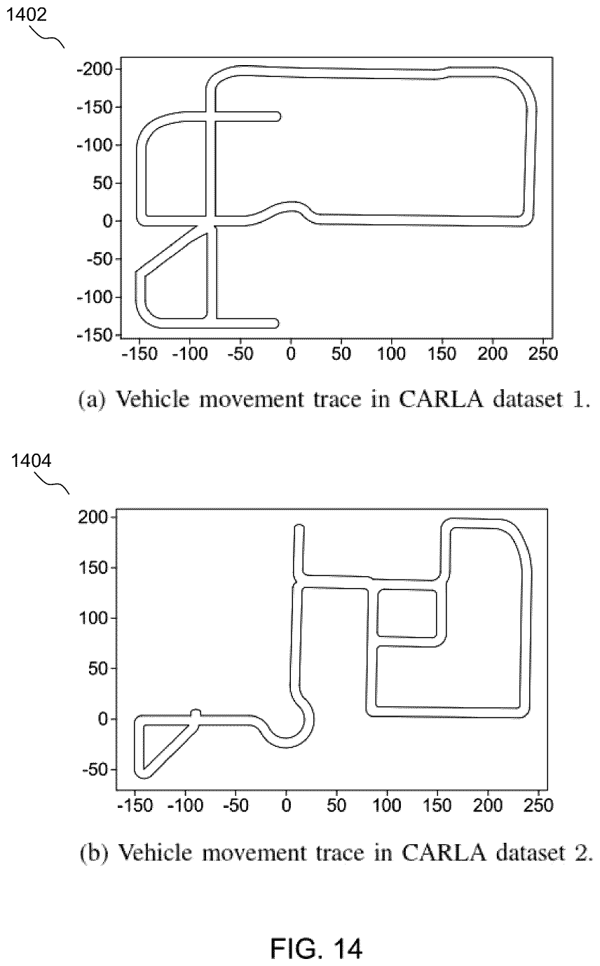

FIG. 14 shows the artificial datasets generated by the CARLA simulator. The datasets include a first CARLA dataset 1402 and a second CARLA dataset 1404. The two datasets have different driving traces in a common town. Each of the first and second CARLA datasets were split into 80% for training, and 20% of testing. Traffic lights, poles, traffic signs, roadside objects (chairs, flowerpots, etc.) were added to the artificial datasets as landmark objects. The partition length is set as length L=2 (metres). The LNN is first trained using the training portion of the first CARLA dataset 1402, and then tested using the testing portion of the same dataset.

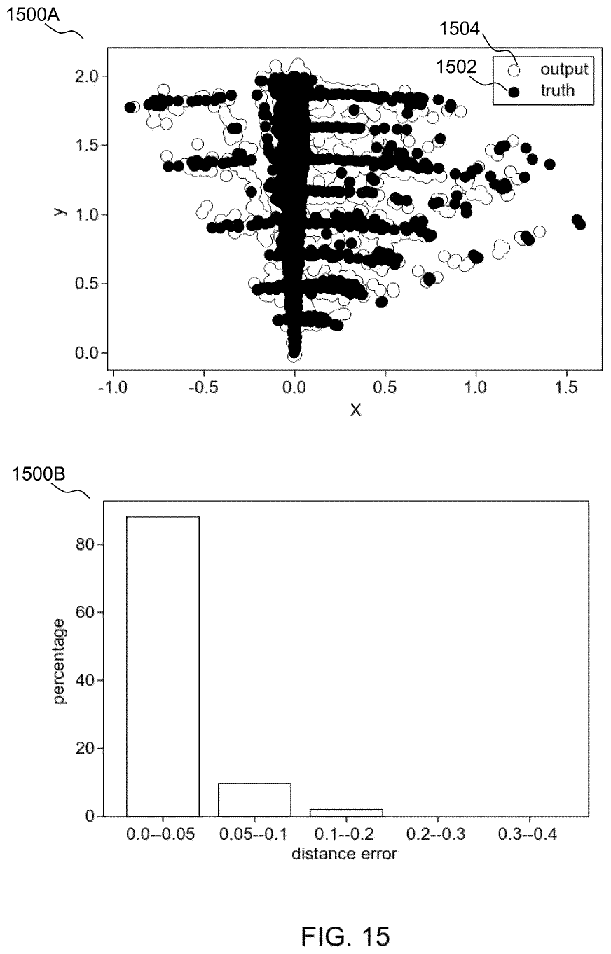

The test results for the first CARLA dataset 1402 with L=2, stated in terms of the root-mean square error (RMSE), is 0.015 m in the x-direction and 0.066 m in the y-direction. The inference time is 0.3 s. The results are also shown visually in FIG. 15.

FIG. 15 shows the test results testing the LNN using the first CARLA dataset 1402, represented by a plot 1500A and a bar chart 1500B. The plot 1500A includes ground truth data points 1502, indicated as black circles in the plot 1500A, and output data points 1504 which are indicated as white circles in the plot 1500A. The output datapoints 1504 were generated by the LNN based on the testing portion of the first CARLA dataset 1402, after it was trained using the training portion of the first CARLA dataset 1402. The bar chart 1500B shows the percentage of output data points in relation to their distance error. About 90% of the output data points achieved a distance error of less than 0.05 m.

Next, the LNN trained using the first CARLA dataset 1402, was tested using the second CARLA dataset 1404. The test results are for the second CARLA dataset 1404 with L=2, stated in terms of the root-mean square error (RMSE), is 0.021 m in the x-direction and 0.078 m in the y-direction. The inference time is 0.3 s. More than 80% of the output data points achieved a distance error of less than 0.05 m. While the LNN performed slightly worse with unseen data from a different driving trace, the localization accuracy remains sufficiently high for practical applications.

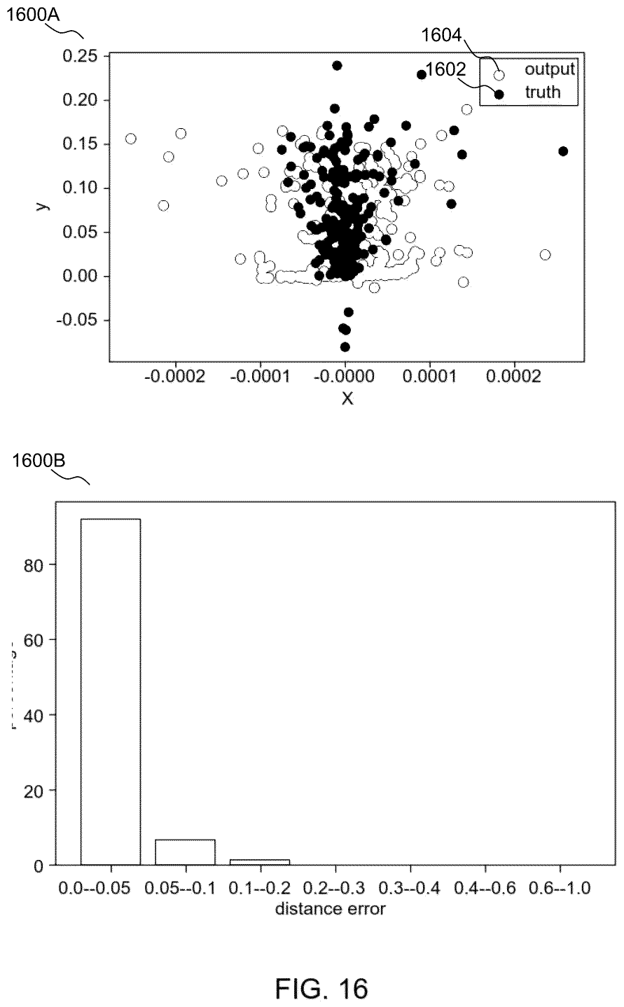

The trained LNN was also tested using real dataset provided by Continental Automotive Pte Ltd. For the real dataset, odometry results obtained using pairs of adjacent frames were used instead of localization results, as the labels were not fully provided in the real dataset. The test results for the real dataset, stated in terms of the root-mean square error (RMSE), is 0.001 m in the x-direction and 0.015 m in the y-direction. The inference time is 0.3 s. The results are also shown visually in FIG. 16.

FIG. 16 shows the test results of testing the LNN using the real dataset, represented by a plot 1600A and a bar chart 1600B. The plot 1600A includes ground truth data points 1602, indicated as black circles in the plot 1600A, and output data points 1604 which are indicated as white circles in the plot 1600A. The bar chart 1600B shows the percentage of output data points in relation to their distance error. From the test results, it is apparent that the centimeter localization accuracy is available for the real dataset under the criterion of Root Mean Squared Error (RMSE). There are over 90% prediction results whose distance errors are less than 0.05 metre. Moreover, the mean of inference time in the real dataset is acceptable in practice. As such, the test results validated the feasibility of the proposed method for determining a position of a vehicle.

FIG. 17 shows a flow diagram of the method 100 for determining a position of a vehicle according to various embodiments.

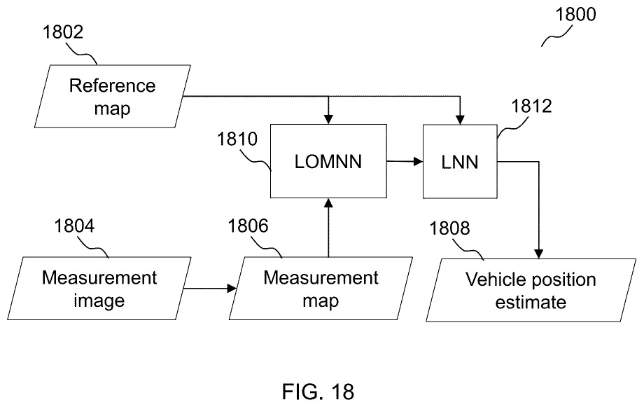

FIG. 18 shows a simplified schematic diagram of a localization framework 1800 according to various embodiments.

Referring to both FIGS. 17 and 18, the method 100 may include the following steps: in a first step 1702, a reference map 1802 is provided. The reference map 1802 comprises segmentations of a reference image with landmarks. In a second step 1704, a measurement image 1804 of a vehicle environment is captured. In a third step 1706, segmentations of the measurement image 1804 and neighborhood graphs are determined to obtain a measurement map, wherein a segmentation is represented by a vertex and where a neighborhood graph comprises the vertex and edges containing information to identify neighboring vertices of the vertex. In a fourth step 1708, segmentations of the reference image (as provided in the reference map 1802) are compared with the segmentations represented by the vertices of the measurement image 1804 and the neighborhood graphs and segmentations contained in the reference image and in measurement image are determined. In a fifth step 1710, the vehicle's location/position is estimated, i.e., determined, with reference to the reference map 1802 during its movement along a road based on a result of the comparison.

The LOMNN 1810 may find matching landmark objects that appear in both the reference map 1802 and the measurement map 1806. The LNN 1812 may output the vehicle position estimate 1808 based on the matching results provided by the LOMNN 1810, and the reference map 1802.

In the context of the present embodiment, a segmentation can be regarded as a part of an image. As a simple example, a grid is laid over the image, and a segmentation may be a rectangular grid element in this case. However, the segmentation may be of any shape. In the described method, the segmentations are determined such that they correspond to landmark objects, as described further below in more detail. Although the complete image may be divided into segmentations, segmentations of most interest for the algorithm and method described herein may contain a landmark or a detail of a landmark. The complete image which is divided into segmentations is also referred to as “frame” herein.

The reference map 1802 is determined once in a first phase of the method and is used for calibration purposes. The term “reference image” is also referred to “reference map image”. The expression “map” refers in general to a set of graphs containing vertices and their edges”. The reference map contains segmentations of static landmarks. Therefore, the reference map is also referred to herein, as landmark map, or landmark calibration map.

As will be explained hereinafter in more detail in the context of particular embodiments, the fifth step 1710, i.e., the estimation of the vehicle's location/position with reference to the reference map 1802 during its movement along a road is based on a matching. The matching may be performed by the LOMNN 1810.

According to an embodiment which may be combined with any above-described embodiment or with any below described further embodiment, the step comparing segmentations of the reference image with the segmentations represented by the vertices of the measurement image 1804 and the neighborhood graphs comprises the step: performing a rough localization to determine a road partition, which the vehicle is currently in, and selecting a reference image from the reference map 1802 that is related to the road partition. A rough position may be used for determining a reference image of the reference map 1802 such that the content of the images is similar, that is, contains at least in parts the same object. The rough position may be estimated using an external system such as a navigation system. The navigation system may be a satellite system such as a GNSS system, which may be augmented by an overlay system such as EGNOS or DGNSS (differential GNSS), and/or which may be supported by additional on-board sensors. As is understood by the skilled reader, also other systems can be used.

The expression “rough localization” means that the accuracy of the localization should be sufficient to determine the road partition in which the vehicle is driving at the time of measurement. The accuracy may, for example be half the length interval of the road partition, that is, for example, in the order of half a meter, a meter or even several meters. At the border of a road partition, it is allowed that the determined road partition is falsely a next road partition.

The vehicle's location is hence estimated from a regression neural network by comparing the extracted features from the equipped sensors' real-time measurements and the calibration landmark map. By performing the matching between the vertices in the graph of the measurement map and the landmark map common objects are determined, that is snapshots of the same static roadside object.

According to an embodiment which may be combined with any above-described embodiment or with any below described further embodiment, the step comparing segmentations of the reference map with the segmentations represented by the vertices of the measurement image and the neighborhood graphs comprises selecting an object from a set of objects contained in an image, wherein a segmentation represents an object. In this embodiment, the images contain a set of objects. The segmentations are defined such that they contain an object. The objects for the comparison may be selected randomly. The comparison including the selection are therefore performed repeatedly.

According to an embodiment which may be combined with any above-described embodiment or with any below described further embodiment, the step comparing segmentations of the reference image with the segmentations represented by the vertices of the measurement image and the neighborhood graphs comprises extracting features from a segmentation of a selected object by a first Resnet. and extracting features from the LiDAR data of the selected object by a first PointNet and providing the extracted features to a common PointNet. As is understood by the skilled reader, a PointNet is a simple and effective Neural Net for point cloud recognition, and a ResNet is known as residual neural network, which is a deep learning model. In particular, similar to the conventional image processing methods based on neural networks, the Resnets are adopted to extract the high dimensional features for the segmentations. The PointNets are exploited to handle the corresponding LiDAR data, that is, the LiDAR points cloud.

According to an embodiment which may be combined with any above-described embodiment or with any below described further embodiment, the step of comparing segmentations of the reference map with the segmentations represented by the vertices of the measurement image and the neighborhood graphs comprises additionally: extracting features from neighbor segmentations of the segmentation of the selected object and providing the extracted features to a GAT, extracting features from LiDAR points cloud of a neighboring object of the selected object and providing the extracted features to the GAT, and describing the extracted features containing spatial information, and providing the described reference image features to the common PointNet. This corresponds to the previous embodiment, however using neighborhood graphs, that is, the vertices neighbored to the vertex or segmentation of the selected object.

According to an embodiment which may be combined with any above-described embodiment or with any below described further embodiment, the previous steps are performed for the reference image and the measurement image, and the method further comprises the step concatenating the extracted features from the first ResNet, the first PointNet and the GAT and determining a similarity between the features of the object of the reference image and the features of the object of the measurement image. In other words, all previously described outputs, i.e. from the first Resnet and first PointNet, and of the GAT are provided to the common PointNet, which actually performs the comparison.

According to an embodiment which may be combined with any above-described embodiment or with any below described further embodiment, the step determining a similarity between the features of the object of the landmark map network part and the features of the object of the measurement map part comprises predicting labels by a Multi-Layer Perceptron (MLP) and calculating a loss function by calculating a cross entropy. The cross entropy contains the true label and predicted label.

According to an embodiment which may be combined with any above-described embodiment or with any below described further embodiment, the step providing a reference map, the reference map comprising segmentations with landmarks comprises the sub-steps: capturing LIDAR data points and a reference map image along a road for a road partition, mapping the LIDAR data points to the reference image, determining objects on the reference image and landmark segmentations from the reference image using a semantic segmentation neural network, and constructing a graph topological landmark map containing vertices corresponding each to a segmentation and edges, where an edge identifies neighboring vertices of an vertex.

Images are captured in pre-defined length intervals along the road. These intervals in terms of distance a referred to road partitions. The reference map image contains at least this part of the road and the environment visible from the point where the image is captured, i.e. the beginning of the interval.

For the determination of objects, a semantic segmentation neural network is used. By the semantic segmentation an intermediated image is obtained that distinguishes object types such as buildings, roads, trees, traffic lights, etc., where details and colors, shades etc. are disregarded, so that it contains semantic information. This intermediate image is used to determine objects which are mapped to segmentations. That is, the segmentations are cropped from the original image using the semantic information of the intermediate image. Only static roadside objects are regarded while dynamic objects are omitted. The resulting segmentation are also referred to as (cropped) instance segmentations or landmark segmentations. The cropped segmentations may be resized to, for example, 256×256 pixels with paddings.

A vertex corresponds to a segmentation, and a segmentation corresponds to an object. The object has a coordinate that is determined by averaging over the captured LiDAR points. The semantic segmentation neural network may be based, for example on a so-called DeepLabV3 architecture.

According to various embodiments, a computer program element for determining matching landmark objects is provided that comprises a landmark map network part and measurement map part. Each of the landmark map network part and measurement map part comprises an object selection module configured to select an object from a set of objects contained in an image, a Resnet configured to extract features from a first segmentation of the selected object and providing the extracted features to a common PointNet, a PointNet configured to extract features from a first LiDAR point cloud of the selected object and providing the extracted features to the common PointNet, a second Resnet configured to extract features from neighbor segmentations of the first segmentation and providing the extracted features to a GAT, and a second PointNet configured to extract features from LiDAR points cloud of the neighboring object of the selected object and providing the extracted features to a GAT. The GAT is configured to describe the extracted features containing spatial information, and to provide the described landmark map features to the common PointNet. The common PointNet configured to concatenate the extracted features from the first ResNet, the first PointNet and the GAT and to determine a similarity between the features of the object of the landmark map network part and the features of the object of the measurement map part.

The Resnets are adopted to extract the high dimensional features for the landmark segmentations

The computer program element defined in this way is also referred to as Landmark objects matching neural network, LOMNN, herein. As is clear to the skilled reader, any module described herein is to be understood as a software module. It is known to a skilled person that any software operation may also be performed by hardware, that is, any a software module may be replaced by a hardware module performing the same functions.

The computer program element may be part of a computer program, but it can also be an entire program by itself. For example, the computer program element may be used to update an already existing computer program to get to the present embodiment.

According to various embodiments, a computer readable medium on which a computer program element is provided.

The computer readable medium may be seen as a storage medium, such as for example, a USB stick, a CD, a DVD, a data storage device, a hard disk, or any other medium on which a program element as described above can be stored.

While embodiments of the present application have been particularly shown and described with reference to specific embodiments, it should be understood by those skilled in the art that various changes in form and detail may be made therein without departing from the spirit and scope of the present application as defined by the appended claims. The scope of the present application is thus indicated by the appended claims and all changes which come within the meaning and range of equivalency of the claims are therefore intended to be embraced. It will be appreciated that common numerals, used in the relevant drawings, refer to components that serve a similar or the same purpose.

It will be appreciated to a person skilled in the art that the terminology used herein is for the purpose of describing various embodiments only and is not intended to be limiting of the present application. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims.

1. A method of determining a position of a vehicle, the method comprising:
capturing a measurement image of a vehicle environment;
determining segmentations represented by a vertex of the measurement image and neighborhood graphs, wherein the neighborhood graph comprises the vertex and edges containing information to identify neighboring vertices of the vertex, to obtain a measurement map;
comparing segmentations of a reference map comprising segmentations of a reference image with landmarks to the segmentations represented by the vertices of the measurement image and the neighborhood graphs;
determining segmentations contained in the reference map and in the measurement image; and
estimating the position of the vehicle based on the reference map during movement of the vehicle based on a result of the comparison.

2. The method according to claim 1, wherein comparing the segmentations of the reference map to the segmentations represented by the vertices of the measurement image and the neighborhood graphs comprises performing a rough localization to determine a road partition on which the vehicle moves and selecting a reference image from the reference map related to the road partition.

3. The method according to claim 1, wherein comparing the segmentations of the reference map with the segmentations represented by the vertices of the measurement image and the neighborhood graphs comprises selecting an object from a set of objects contained in an image, and
wherein a segmentation represents an object.

4. The method according to claim 1, wherein comparing the segmentations of the reference image with the segmentations represented by the vertices of the measurement image and the neighborhood graphs comprises:
capturing real-time LiDAR data of the vehicle environment;
extracting features from a segmentation of a selected object by a first Resnet;
extracting features from the LiDAR data of the selected object by a first PointNet; and
providing the extracted features to a common PointNet.

5. The method according to claim 4, wherein comparing the segmentations of the reference map with the segmentations represented by the vertices of the measurement image and the neighborhood graphs comprises:
extracting features from neighbor segmentations of the segmentation of the selected object and providing the extracted features to a GAT;
extracting features from LiDAR points cloud of a neighboring object of the selected object and providing the extracted features to the GAT;
describing the extracted features containing spatial information; and
providing the described reference image features to the common PointNet.

6. The method according to claim 5, further comprising:
concatenating the extracted features from the first ResNet, the first PointNet and the GAT; and
determining a similarity between the features of the object of the reference image and the features of the object of the measurement image.

7. The method according to claim 6, wherein determining the similarity between the features of the object of the landmark map network part and the features of the object of the measurement map part comprises predicting labels by a Multi-Layer Perceptron (MLP) and calculating a loss function by calculating a cross entropy.

8. The method according to claim 1, wherein providing the reference map comprises:
capturing LIDAR data points and a reference image along a road for a road partition;
mapping the LIDAR data points to the reference image;
determining objects on the reference image and determining landmark segmentations from the reference image using a semantic segmentation neural network; and
constructing a graph topological landmark map containing vertices corresponding each to a segmentation and edges, wherein an edge identifies neighboring vertices of a vertex.

9-10. (canceled)
